(19) United States
(12) Patent Application Publication
(10) Pub. No.: US 2014/0333979 A1
(43) Pub. Date: Nov. 13, 2014

(54) LASER SCANNING DEVICE AND CONTROL METHOD THEREOF

(71) Applicants: Chi-Hsun Huang, Hsin-Chu (TW); Lei-Chih Chang, Hsin-Chu (TW); Chung-Lung Yang, Hsin-Chu (TW); Ming-Te Lin, Hsin-Chu (TW)

(72) Inventors: Chi-Hsun Huang, Hsin-Chu (TW); Lei-Chih Chang, Hsin-Chu (TW); Chung-Lung Yang, Hsin-Chu (TW); Ming-Te Lin, Hsin-Chu (TW)

(73) Assignee: Coretronic Corporation, Hsin-Chu (TW)

(21) Appl. No.: 14/259,122

(22) Filed: Apr. 22, 2014

(30) Foreign Application Priority Data
May 13, 2013 (CN) 201310174219.9

(51) Int. Cl. G02B 26/10

(52) U.S. Cl. CPC G02B 26/105
USPC 359/213.1

(57) ABSTRACT

A laser scanning device and a control method thereof are provided. The method includes: providing a control signal to an oscillating reflective mirror of the device; setting a frequency of the control signal gradually decreased from a maximal-setting-value of a resonant frequency of the mirror; judging whether a light detector receives a laser light reflected by the mirror according to an edge signal of the detector; judging whether a pulse width of the edge signal is equal to a predetermined pulse width when the detector receives the laser light: (1) increasing the frequency of the control signal when the pulse width of the edge signal is greater than the predetermined pulse width, (2) decreasing the frequency of the control signal when the pulse width of the edge signal is less than the predetermined pulse width. The time and labor for measuring the scanning frequency of the mirror may be saved.

### CROSS-REFERENCE TO RELATED APPLICATION

This application claims the priority benefit of China application serial no. 201310174219.9, filed on May 13, 2013. The entirety of the above-mentioned patent application is hereby incorporated by reference herein and made a part of this specification.

### BACKGROUND OF THE INVENTION

1. Field of the Invention

The invention generally relates to a scanning device and a control method thereof, and more particularly, to a laser scanning device and control method thereof.

2. Description of Related Art

The laser beam features good collimation, higher power and higher light intensity, so that the laser generator has a very wide range of applications in modern industry, for example, it serves as a highly collimated light source in laboratories, a laser pen for presentation, a laser source for reading or burning optical discs, a laser source used in laser mouse, a laser source for various measuring instruments, a laser source for display field, a laser source in fiber optic communications, and even as a laser source for biomedical instruments and so on.

When the laser light is applied to scan an object, the line light source of laser must be converted into a planar light source. And, in order not to affect the collimation of the laser light, a laser scanning device will provide different reflection angles through back and forth swing of a reflective element so as to make the line light source of laser converted into a planar laser source through time. Accordingly, whether or not normal running of the reflective element is considered as a key for designing a laser scanning device.

US Patent Publication No. 2011/0320046 discloses a driving method for starting and operating a resonant scanning micro-electromechanical system (MEMS) device at its resonant frequency. The scanning MEMS device includes a torsional oscillating mirror and is configured to control the resonant frequency of the above-mentioned torsional oscillating mirror under a situation affecting the resonant frequency thereof by means of a closed-loop feedback device and applying a method of the above-mentioned device. The method is implemented with a simple algorithm (by using software or hardware for implementation) so as to maintain the resonant condition or other selected frequency.

U.S. Pat. No. 7,107,848 discloses an active scan velocity control for a MEMS scanner providing a method and a system of adjusting the operation parameters of the component that drifts with temperature changes. The system includes a torsional hinged device oscillating at a resonant frequency, and the resonant frequency of the torsional hinged device drifts or varies along with the temperature. The system further includes a driving mechanism able to produce a driving signal and a sensing circuit with a light sensor. The driving signal has a frequency optionally equivalent to the resonant frequency of the torsional hinged device, and the light sensor is configured to sense the rotational amplitude or the phase shift of the torsional hinged device. According to the sensed rotational amplitude or the phase shift, the light sensor correspondingly produces a signal transmitted to the driving mechanism so as to further adjust the frequency of the driving signal to the actual resonant frequency corresponding to the present circumstance.

### SUMMARY OF THE INVENTION

Accordingly, the invention is directed to a laser scanning device and a control method thereof, which are capable of adjusting the frequency of a control signal to the resonant frequency of an oscillating reflective mirror.

Other objectives and advantages of the invention should be further indicated by the disclosures of the invention, and omitted herein for simplicity.

To achieve one of, a portion of, or all of the above-mentioned objectives or other objectives, the invention provides a control method of a laser scanning device, which includes following steps: providing a control signal to an oscillating reflective mirror of the laser scanning device, the oscillating reflective mirror has a resonant frequency with a predetermined range, and the control signal enables the oscillating reflective mirror to swing back and forth; setting a frequency of the control signal to be gradually decreased from a maximal setting value of the resonant frequency with the predetermined range of the oscillating reflective mirror; judging whether or not a light detector receives a laser light reflected by the oscillating reflective mirror according to an edge signal provided by the light detector of the laser scanning device; and judging whether or not a pulse width of the edge signal is equal to a predetermined pulse width when the light detector receives the laser light reflected by the oscillating reflective mirror: (1) increasing the frequency of the control signal when the pulse width of the edge signal is greater than the predetermined pulse width, or (2) decreasing the frequency of the control signal when the pulse width of the edge signal is less than the predetermined pulse width.

In an embodiment of the invention, the step of setting the frequency of the control signal to be gradually decreased from the maximal setting value of the resonant frequency with the predetermined range of the oscillating reflective mirror includes: setting the frequency of the control signal to be gradually decreased by about 0.5 Hz each time from the maximal setting value of the resonant frequency with the predetermined range of the oscillating reflective mirror.

In an embodiment of the invention, the step of increasing the frequency of the control signal includes: gradually increasing the frequency of the control signal by about 0.04 Hz each time; and the step of decreasing the frequency of the control signal includes: gradually decreasing the frequency of the control signal by about 0.04 Hz each time.

In an embodiment of the invention, the step of judging whether or not the light detector receives the laser light reflected by the oscillating reflective mirror is executed once in a first presetting time, wherein the first presetting time is 100 milliseconds.

In an embodiment of the invention, the step of judging whether or not the pulse width of the edge signal is equal to the predetermined pulse width is executed once in a second presetting time, wherein the second presetting time is 3 seconds.

In an embodiment of the invention, the second presetting time is greater than the first presetting time.

To achieve the above-mentioned or other objectives, the invention provides a laser scanning device including an oscillating reflective mirror, a laser source, a light detector and, a control unit. The oscillating reflective mirror has a resonant frequency with a predetermined range, and is configured to receive a control signal to swing back and forth. The laser source is configured to provide a laser light to the oscillating reflective mirror. The light detector is configured to detect whether or not a reflective angle of the laser light reflected by the oscillating reflective mirror is greater than a predetermined threshold angle so as to accordingly provide an edge signal. The control unit is electrically connected to the oscillating reflective mirror, the laser source and the light detector, and configured to receive the edge signal and provide the control signal. The control unit sets a frequency of the control signal to be gradually decreased from a maximal setting value of the resonant frequency with the predetermined range of the oscillating reflective mirror. The control unit judges whether or not the light detector receives the laser light reflected by the oscillating reflective mirror according to the edge signal. When the light detector receives the laser light reflected by the oscillating reflective mirror, the control unit judges whether or not a pulse width of the edge signal is equal to a predetermined pulse width: (1) the control unit increases the frequency of the control signal when the pulse width of the edge signal is greater than the predetermined pulse width, or (2) the control unit decreases the frequency of the control signal when the pulse width of the edge signal is less than the predetermined pulse width.

Based on the description above, the laser scanning device and the control method thereof of the embodiment of the invention may automatically adjust the frequency of the control signal to the resonant frequency of the oscillating reflective mirror, therefore the time and labor for measuring the scanning frequency of the oscillating reflective mirror may be saved. Besides, the frequency of the control signal may be adjusted according to the temperature variation to avoid the oscillating reflective mirror without normal operation due to an excessive temperature variation.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a system diagram of a laser scanning device according to an embodiment of the invention.

FIG. 2 is a flowchart of a control method of a laser scanning device according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

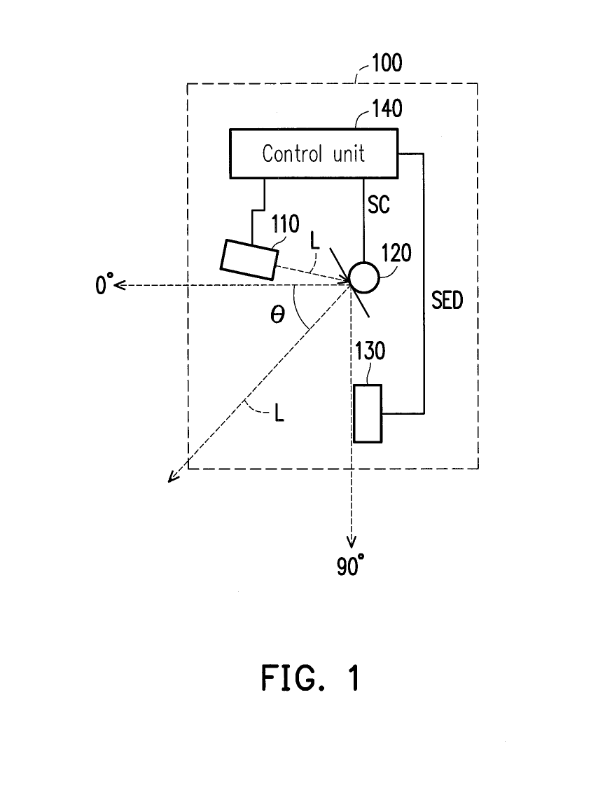

Referring to FIG. 1, in the embodiment, a laser scanning device 100 includes a laser source 110, an oscillating reflective mirror 120, a light detector 130, and a control unit 140. The laser source 110 is configured to emit a laser light L and provide the laser light L to the oscillating reflective mirror 120. The oscillating reflective mirror 120 has a resonant frequency with a predetermined range, and the oscillating reflective mirror 120 receives a control signal SC followed by swinging back and forth so as to reflect the laser light L provided by the laser source 110 and sequentially provide the laser light L having different reflective angles (such as 0°, θ, and 90°) and further make the laser light L scan in an effective scan area (not marked).

The light detector 130 is disposed at an edge of the effective scan area for detecting whether or not the reflective angle (for example, θ) of the laser light L reflected by the oscillating reflective mirror 120 is greater than a threshold angle (for example but not limited, 90° herein). That is, when the reflective angle of the laser light L reaches the threshold angle, the edge of the effective scan area would be scanned. At that time, the laser light L would be detected by the light detector 130, and the light detector 130 accordingly provides an edge signal SED. The control unit 140 is electrically connected to the laser source 110, the oscillating reflective mirror 120 and the light detector 130 to receive the edge signal SED and provide the control signal SC according to the edge signal SED.

When the laser scanning device 100 is started, the control unit 140 turns on the laser source 110 and then the control unit 140 provides the control signal SC to the oscillating reflective mirror 120 firstly. In the embodiment, the control signal SC is a pulse width modulation signal (PWM signal), and the frequency of the control signal SC is set with the maximal setting value of the resonant frequency having the predetermined range of the oscillating reflective mirror 120, for example, 2.3 kHz; and the frequency of the control signal SC would be gradually decreased from the maximal setting value of the resonant frequency until the control unit 140 receives the edge signal SED. In more details, the control unit 140 judges whether or not the light detector 130 receives the laser light L reflected by the oscillating reflective mirror 120 according to the edge signal SED, i.e., the control unit 140 judges whether or not the reflective angle (for example, θ) of the laser light L reflected by the oscillating reflective mirror 120 is greater than a threshold angle (for example, 90° herein).

Moreover, it is assumed that the light detector 130 outputs the edge signal SED with a low voltage level when the light detector 130 does not receive the laser light L and the light detector 130 outputs the edge signal SED with a high voltage level when the light detector 130 receives the laser light L. Accordingly, when the light detector 130 receives the laser light L reflected by the oscillating reflective mirror 120, the edge signal SED would form a pulse; on the contrary, when the light detector 130 does not receive the laser light L reflected by the oscillating reflective mirror 120, the edge signal SED would not form a pulse. Therefore, the control unit 140 may determine whether or not the light detector 130 receives the laser light L reflected by the oscillating reflective mirror 120 according to whether or not the edge signal SED forms a pulse.

In addition, due to the static friction force, the first scanning after the oscillating reflective mirror 120 is started has a larger force so that the light detector 130 may receive the laser light L reflected by the oscillating reflective mirror 120 when the oscillating reflective mirror 120 swings at the first time. In order to avoid the above-mentioned error, the control unit 140 may ignore the pulse formed by the edge signal SED at the first time to avoid the above-mentioned misjudgement.

Then, when the light detector 130 receives the laser light L reflected by the oscillating reflective mirror 120, it represents the frequency of the control signal SC is close to the scanning frequency of the oscillating reflective mirror 120, i.e., the oscillating reflective mirror 120 swinging back and forth in the scanning frequency range may normally operate in the effective scan area. However, the resonant frequency of the oscillating reflective mirror 120 would be different with the ambient temperature or the temperature variation during operating the device. Thus, the control unit 140 would judge whether or not the pulse width of the edge signal SED is equal to a predetermined pulse width so as to determine whether or not the scanning frequency of the oscillating reflective mirror 120 is maintained in the predetermined range by comparing the pulse width of the edge signal SED with the predetermined pulse width and to adjust the frequency of the control signal SC according to the comparison result. In this way, the influence on the resonant frequency of the oscillating reflective mirror 120 due to the temperature variation gets compensated.

Further, when the pulse width of the edge signal SED is greater than the predetermined pulse width, it means the scanning frequency (or the scanning rate) of the oscillating reflective mirror 120 is too low, while the control unit 140 increases the frequency of the control signal SC so as to increase the scanning frequency (or the scanning rate) of the oscillating reflective mirror 120. When the pulse width of the edge signal SED is less than the predetermined pulse width, it means the scanning frequency (or the scanning rate) of the oscillating reflective mirror 120 is too high, while the control unit 140 decreases the frequency of the control signal SC so as to decrease the scanning frequency (or the scanning rate) of the oscillating reflective mirror 120; when the pulse width of the edge signal SED is equal to the predetermined pulse width, it means the scanning frequency (or the scanning rate) of the oscillating reflective mirror 120 is just enough, while the control unit 140 maintains the frequency of the control signal SC so as to maintain the scanning frequency (or the scanning rate) of the oscillating reflective mirror 120, and the oscillating reflective mirror 120 may swing with the scanning frequency having the predetermined range and keep the reflected laser light L in the effective scan area.

According to the above-mentioned depiction, the laser scanning device 100 of the invention may automatically adjust the frequency of the control signal SC to the normally operated scanning frequency of the oscillating reflective mirror 120, therefore the time and labor for measuring the scanning frequency of the oscillating reflective mirror 120 may be saved, and the laser scanning device 100 may correspondingly adjust the frequency of the control signal SC according to the temperature variation to avoid the oscillating reflective mirror 120 from failing normal operating due to an excessive temperature variation.

In an embodiment of the invention, when the light detector 130 does not receive the laser light L reflected by the oscillating reflective mirror 120, the control unit 140 sets the frequency of the control signal SC to be gradually decreased from the maximal setting value of the resonant frequency with the predetermined range of the oscillating reflective mirror 120 by about 0.5 Hz each time. For example, the oscillating reflective mirror 120 swings back and forth correspondingly at the first time based on the frequency of the control signal SC being 2300 Hz, and then the oscillating reflective mirror 120 swings back and forth correspondingly at the second time based on the frequency of the control signal SC being about 2299.5 Hz, and the rest may be deduced by analogy. Otherwise, when the oscillating reflective mirror 120 receives the corresponding control signal SC once, the oscillating reflective mirror 120 swings back and forth in a first presetting time first, then the control unit 140 would deliver the next corresponding control signal SC to the oscillating reflective mirror 120. That is, after receiving the control signal SC with the frequency of 2300 Hz and after the swinging back and forth during the first presetting time, the oscillating reflective mirror 120 would receive the control signal SC with the frequency of about 2299.5 Hz until the control unit 140 receives the edge signal SED from the light detector 130.

In an embodiment of the invention, when the pulse width of the edge signal SED is greater than the predetermined pulse width, the control unit 140 gradually increases the frequency of the control signal SC by about 0.04 Hz each time. It is not limit the valve of frequency as 0.04 Hz. For example, the current frequency of the corresponding control signal SC for the oscillating reflective mirror 120 is 2100 Hz, the corresponding frequency of the control signal SC for the next scanning of the oscillating reflective mirror 120 is about 2100.04 Hz, and the rest may be deduced by analogy. On the other hand, when the pulse width of the edge signal SED is less than the predetermined pulse width, the control unit 140 gradually decreases the frequency of the control signal by about 0.04 Hz each time. For example, the current frequency of the corresponding control signal SC for the oscillating reflective mirror 120 is 2100 Hz, the corresponding frequency of the control signal SC for the next scanning of the oscillating reflective mirror 120 is about 2099.96 Hz, and the rest may be deduced by analogy.

In an embodiment of the invention, the control unit 140 executes an operation in the first presetting time that judges whether or not the light detector 130 receives the laser light L reflected by the oscillating reflective mirror 120, i.e., in every first presetting time, to judge whether or not the light detector 130 receives the laser light L reflected by the oscillating reflective mirror 120 is executed once. In addition, in a second presetting time, the control unit 140 executes an operation that judges whether or not the pulse width of the edge signal SED is equal to the predetermined pulse width, i.e., in every second presetting time, to judge whether or not the pulse width of the edge signal SED is equal to the predetermined pulse width is executed once.

In an embodiment of the invention, the second presetting time is greater than the first presetting time mentioned above. For example, the first presetting time may be 100 milliseconds and the second presetting time may be 3 seconds. The above-mentioned time may be designed according to the components used by the laser scanning device 100 or a person of ordinary skill in the art, which the invention is not limited to.

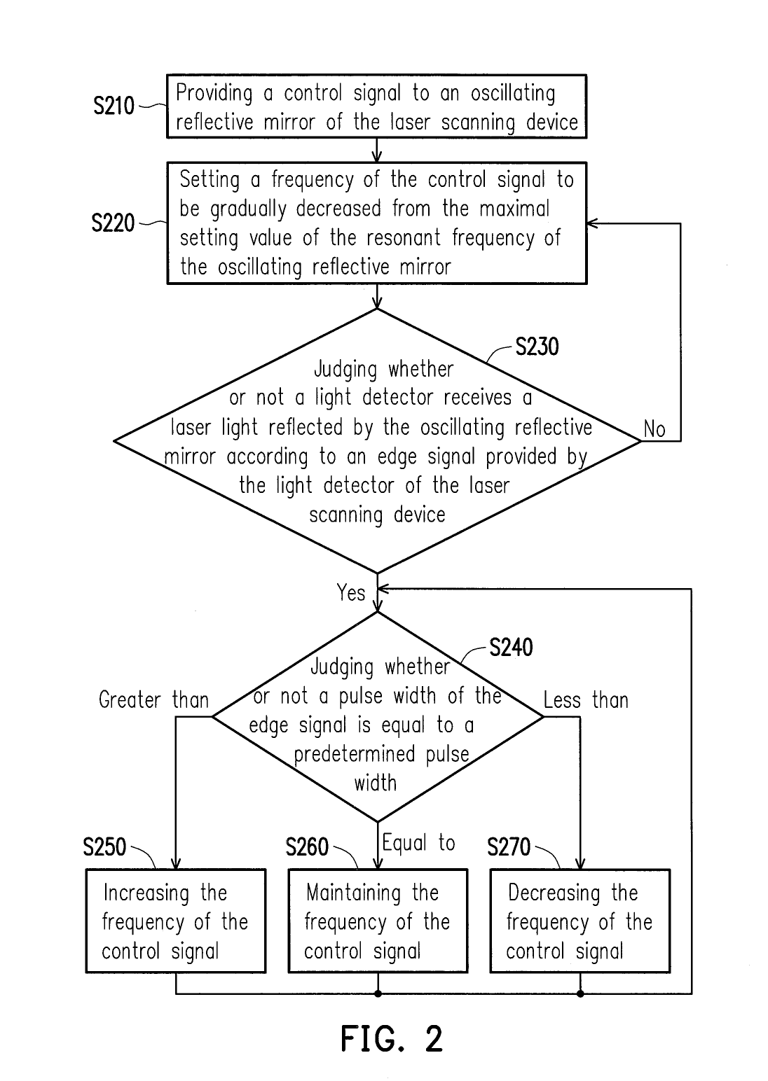

Referring to FIG. 2, in the embodiment, the control method of a laser scanning device includes following steps: a control signal is provided to an oscillating reflective mirror of the laser scanning device (step S210), and a frequency of the control signal is set to be gradually decreased from a maximal setting value of a resonant frequency with a predetermined range of the oscillating reflective mirror (step S220); then whether or not a light detector receives a laser light reflected by the oscillating reflective mirror is judged according to an edge signal provided by the light detector of the laser scanning device (step S230); the procedure goes back to step S220 to gradually decrease the frequency of the control signal when the light detector does not receive the laser light reflected by the oscillating reflective mirror, i.e., when the judging result in step S230 is “no”; whether or not a pulse width of the edge signal is equal to a predetermined pulse width is continuously judged (step S240) when the light detector receives the laser light reflected by the oscillating reflective mirror, i.e., when the judging result in step S230 is “yes”.

Further, the frequency of the control signal is increased (step S250) when the pulse width of the edge signal is greater than the predetermined pulse width, i.e., the judging result in step S240 is “greater than”; the frequency of the control signal is maintained (step S260) when the pulse width of the edge signal is equal to the predetermined pulse width, i.e., the judging result in step S240 is “equal to”; the frequency of the control signal is decreased (step S270) when the pulse width of the edge signal is less than the predetermined pulse width, i.e., the judging result in step S240 is “less than”; and after steps S250, S260 and S270, the procedure goes back to step S240 to maintain the frequency of the control signal to further maintain the scanning frequency able to normally drive the oscillating reflective mirror to swing back and forth. The sequence of the above-mentioned steps S210, S220, S230, S240, S250, S260, and S270 is an example, which the invention is not limited to. The details of the above-mentioned steps S210, S220, S230, S240, S250, S260, and S270 may refer to the embodiments of FIGS. 1 and 2, which is omitted for simplicity.

In summary, the laser scanning device and the control method thereof of the embodiment of the invention may automatically adjust the frequency of the control signal to a scanning frequency to enable the normal operation of the oscillating reflective mirror so as to save the time and labor for measuring the scanning frequency of the oscillating reflective mirror. In addition, the frequency of the control signal may be correspondingly adjusted according to the temperature variation to avoid the oscillating reflective mirror without normal operation due to an excessive temperature variation.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Furthermore, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A control method of a laser scanning device, comprising:
providing a control signal to an oscillating reflective mirror of the laser scanning device, wherein the oscillating reflective mirror has a resonant frequency with a predetermined range, and the control signal enables the oscillating reflective mirror to swing back and forth;
setting a frequency of the control signal to be gradually decreased from a maximal setting value of the resonant frequency with the predetermined range of the oscillating reflective mirror;
judging whether or not a light detector receives a laser light reflected by the oscillating reflective mirror according to an edge signal provided by the light detector of the laser scanning device; and
judging whether or not a pulse width of the edge signal is equal to a predetermined pulse width when the light detector receives the laser light reflected by the oscillating reflective mirror:
(1) increasing the frequency of the control signal when the pulse width of the edge signal is greater than the predetermined pulse width, or (2) decreasing the frequency of the control signal when the pulse width of the edge signal is less than the predetermined pulse width.

2. The control method of the laser scanning device as claimed in claim 1, wherein the step of setting the frequency of the control signal to be gradually decreased from the maximal setting value of the resonant frequency with the predetermined range of the oscillating reflective mirror comprises:
setting the frequency of the control signal to be gradually decreased by about 0.5 Hz each time from the maximal setting value of the resonant frequency with the predetermined range of the oscillating reflective mirror.

3. The control method of the laser scanning device as claimed in claim 1, wherein the step of increasing the frequency of the control signal comprises: gradually increasing the frequency of the control signal by about 0.04 Hz each time, and the step of decreasing the frequency of the control signal comprises: gradually decreasing the frequency of the control signal by about 0.04 Hz each time.

4. The control method of the laser scanning device as claimed in claim 1, wherein the step of judging whether or not the light detector receives the laser light reflected by the oscillating reflective mirror is executed once in a first presetting time.

5. The control method of the laser scanning device as claimed in claim 4, wherein the first presetting time is 100 milliseconds.

6. The control method of the laser scanning device as claimed in claim 4, wherein the step of judging whether or not the pulse width of the edge signal is equal to the predetermined pulse width is executed once in a second presetting time.

7. The control method of the laser scanning device as claimed in claim 6, wherein the second presetting time is 3 seconds.

8. The control method of the laser scanning device as claimed in claim 6, wherein the second presetting time is greater than the first presetting time.

9. A laser scanning device, comprising:
an oscillating reflective mirror, having a resonant frequency with a predetermined range, and receiving a control signal to swing back and forth;
a laser source, configured to provide a laser light to the oscillating reflective mirror;
a light detector, configured to detect whether or not a reflective angle of the laser light reflected by the oscillating reflective mirror is greater than a predetermined threshold angle so as to accordingly provide an edge signal; and
a control unit, electrically connected to the oscillating reflective mirror, the laser source and the light detector, and configured to receive the edge signal and provide the control signal, wherein the control unit sets a frequency of the control signal to be gradually decreased from a maximal setting value of the resonant frequency with the predetermined range of the oscillating reflective mirror, the control unit judges whether or not the light detector receives the laser light reflected by the oscillating reflective mirror according to the edge signal, and when the light detector receives the laser light reflected by the oscillating reflective mirror, the control unit judges whether or not a pulse width of the edge signal is equal to a predetermined pulse width: (1) the control unit increases the frequency of the control signal when the pulse width of the edge signal is greater than the predetermined pulse width, or (2) the control unit decreases the frequency of the control signal when the pulse width of the edge signal is less than the predetermined pulse width.

10. The laser scanning device as claimed in claim 9, wherein when the light detector does not receive the laser light reflected by the oscillating reflective mirror, the control unit sets the frequency of the control signal to be gradually decreased from the maximal setting value of the resonant frequency with the predetermined range of the oscillating reflective mirror by about 0.5 Hz each time.

11. The laser scanning device as claimed in claim 9, wherein when the pulse width of the edge signal is greater than the predetermined pulse width, the control unit gradually increases the frequency of the control signal by about 0.04 Hz each time, and when the pulse width of the edge signal is less than the predetermined pulse width, the control unit gradually decreases the frequency of the control signal by about 0.04 Hz each time.

12. The laser scanning device as claimed in claim 9, wherein the control unit executes the operation of judging whether or not the light detector receives the laser light reflected by the oscillating reflective mirror once in a first presetting time.

13. The laser scanning device as claimed in claim 12, wherein the first presetting time is 100 milliseconds.

14. The laser scanning device as claimed in claim 12, wherein the control unit executes the operation of judging whether or not the pulse width of the edge signal is equal to the predetermined pulse width once in a second presetting time.

15. The laser scanning device as claimed in claim 14, wherein the second presetting time is 3 seconds.

16. The laser scanning device as claimed in claim 14, wherein the second presetting time is greater than the first presetting time.
